(19) United States
(12) Patent Application Publication
(10) Pub. No.: US 2025/0081882 A1
(43) Pub. Date: Mar. 13, 2025

(54) OUTDOOR POWER MACHINE

(71) Applicant: Greenworks (Jiangsu) Co. Ltd., Changzhou (CN)

(72) Inventors: Qunli Wei, Changzhou (CN); Christopher Eichel, Charlotte, NC (US); Qinghua Shi, Changzhou (CN); Dongdong Shi, Changzhou (CN)

(21) Appl. No.: 18/564,808

(22) PCT Filed: Sep. 15, 2022
(86) PCT No.: PCT/CN2022/118903

§ 371 Date: Nov. 28, 2023

(51) Int. Cl. A01D 34/00; A01D 34/66; A01D 69/02; A01D 101/00

(52) U.S. Cl. CPC A01D 34/006; A01D 34/001; A01D 34/66; A01D 69/02; A01D 2101/00

(57) ABSTRACT

An outdoor power machine includes a chassis. The outdoor power machine also includes two or more drive wheel assemblies that are physically mounted to the chassis and one or more steer wheels. Each drive wheel assembly is coupled to an electric motor. An electric power pack is configured to supply electric energy to the electric motors. A steering lever is provided that includes a speed control button. The speed control button is configured to send a signal to a control system such that the control system sequentially selects a gross speed range.

### BACKGROUND OF THE INVENTION

This invention relates generally to operator interfaces and other features of outdoor power equipment, and more particularly to self-propelled outdoor power machines having integrated gross and fine speed control for a drive motor and for a blade motor.

### BACKGROUND

Various types of outdoor power machines are known. Examples of common machines include lawn mowers and lawn tractors. Some outdoor power machines have an operator seat and are considered “ride-on”, “riders”, or “riding” machines. Others accommodate an operator in a standing position, described as a “stand-on” or “stander” machine.

Some known outdoor power machines are battery powered. They include a battery pack which provides electric power for the primary operating components of the machine, such as the drive wheels and mower deck or other powered implements. The battery pack also provides electric power for controls, displays, and accessories of the machine.

One problem with prior art outdoor power machines is that the drive speed control for forward and reverse speed of the outdoor power machines requires an operator to use different hand positions to regulate gross speed, i.e. high, medium, and low-speed ranges, and fine speed, i.e. regulation between minimum and maximum of a given range.

Another problem with prior art outdoor power machines is that they lack provision for the storage and charging of personal electronic devices such as smart-phones.

### BRIEF SUMMARY OF THE INVENTION

These problems are addressed by an outdoor power machine that has steering levers configured for determining a particular speed with in a given range of speed i.e., the fine control, and a selector button positioned on at least one of the steering levers configured to determine the range of speed, i.e. the gross control (low, medium, high).

According to one aspect of the technology described herein, an outdoor power machine includes: a chassis; two or more drive wheel assemblies physically mounted to the chassis, each drive wheel assembly coupled to an electric motor; an electric power pack configured to supply electric energy to the electric motors; one or more steer wheels; a steering lever; a speed control button positioned on the steering lever; and wherein the speed control button is configured to send a signal to a control system such that the control system sequentially selects a gross speed range.

### BRIEF DESCRIPTION OF THE DRAWINGS

The invention may be best understood by reference to the following description taken in conjunction with the accompanying drawing figures in which:

FIG. 1 is a front perspective view of an exemplary ride-on zero-turn outdoor power machine;

FIG. 2 is a rear perspective view of the machine of FIG. 1;

FIG. 3 is a side elevation view of the machine of FIG. 1;

FIG. 4 is a perspective view of a chassis of the machine of FIG. 1;

FIG. 5 is a front perspective view of an exemplary stand-on zero-turn outdoor power machine;

FIG. 6 is a rear perspective view of the machine of FIG. 5;

FIG. 7 is a side elevation view of the machine of FIG. 5;

FIG. 8 is a perspective view of a chassis of the machine of FIG. 5;

FIG. 9 is a perspective view of an exemplary mowing deck;

FIG. 10 is a bottom plan view of the mowing deck of FIG. 9;

FIG. 11 is a left side plan view of a portion of the machine of FIG. 1;

FIG. 12 is a top plan view of a portion of the machine of FIG. 1;

FIG. 13 is the view of FIG. 12 with a portion removed for clarity;

FIG. 14 is a left side plan view of a portion of the machine of FIG. 1; and

FIG. 15 is a left rear quarter view of a portion of the machine of FIG. 1 with portions removed to more clearly show a charging port.

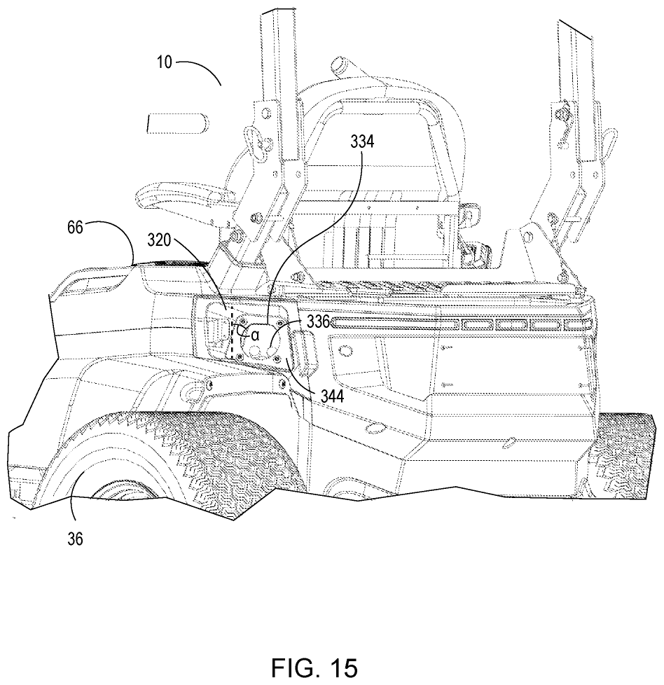

### DETAILED DESCRIPTION OF THE INVENTION

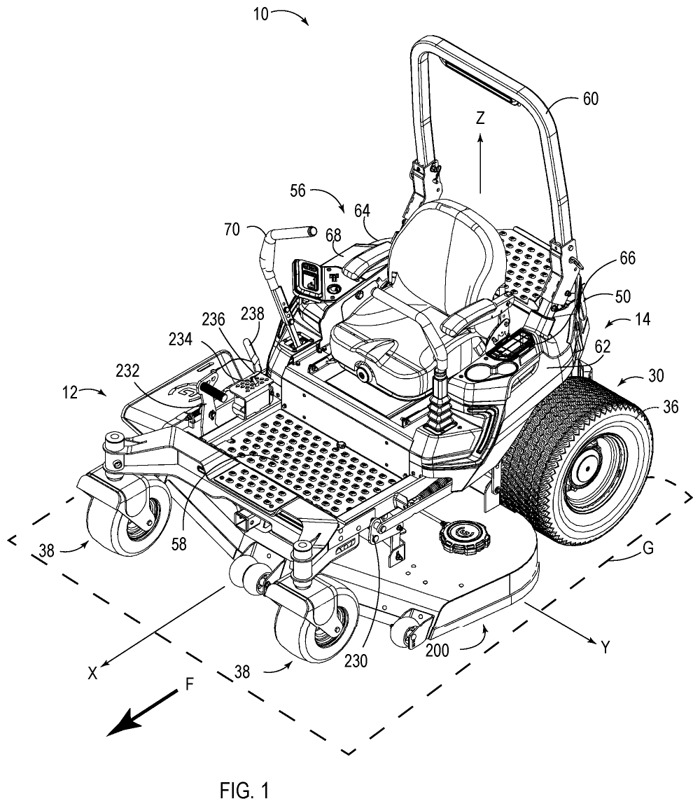

Referring to the drawings wherein identical reference numerals denote the same elements throughout the various views, FIGS. 1-3 show a representative embodiment of an outdoor power machine 10. The machine 10 extends along an axial direction (arrow “X”) between a front end 12 and a rear end 14. The points of contact of the wheels of the machine 10 collectively define a ground plane “G”.

It is noted that, as used herein, the terms “axial” and “longitudinal” both refer to a direction parallel to the axis X, while “vertical” refers to a direction perpendicular to the axial direction and to the ground plane G (see arrow “Z” in FIG. 1) and “lateral” refers to a direction mutually perpendicular to the axial and vertical directions (see arrow “Y” in FIG. 1). A primary forward direction of ground travel is shown by the arrow “F” in FIG. 1. These directional terms are used merely for convenience in description and do not require a particular orientation of the structures described thereby.

In the illustrated example, the outdoor power machine 10 is a zero-turn-radius type machine, alternatively referred to as a “zero-turn” machine. This type of machine is capable of changing its direction of travel (heading) without significant forward or backward movement. This is accomplished by differential rotation of drive wheels on opposite sides of the machine 10 to produce a yawing motion. For example, rotating the right-side wheel forward and simultaneously rotating the left-side wheel backward at the same wheel speed (RPM) will cause the machine 10 to yaw (turn) to the left without moving forwards or backwards. Related steering effects may be obtained by rotating drive wheels on opposite sides in different directions and different wheel speeds, by holding one wheel stationary while driving the opposite-side wheel in a chosen direction, or by rotating the wheels on opposite sides in the same direction at different wheel speeds.

The principles described herein are also applicable to a non zero-turn mower (not shown) using a conventional steering linkage to pivot (steer) some or all of the wheels.

In the example shown in FIGS. 1-3, the machine 10 is a ride-on machine (alternatively referred to as a “rider” or “riding machine”).

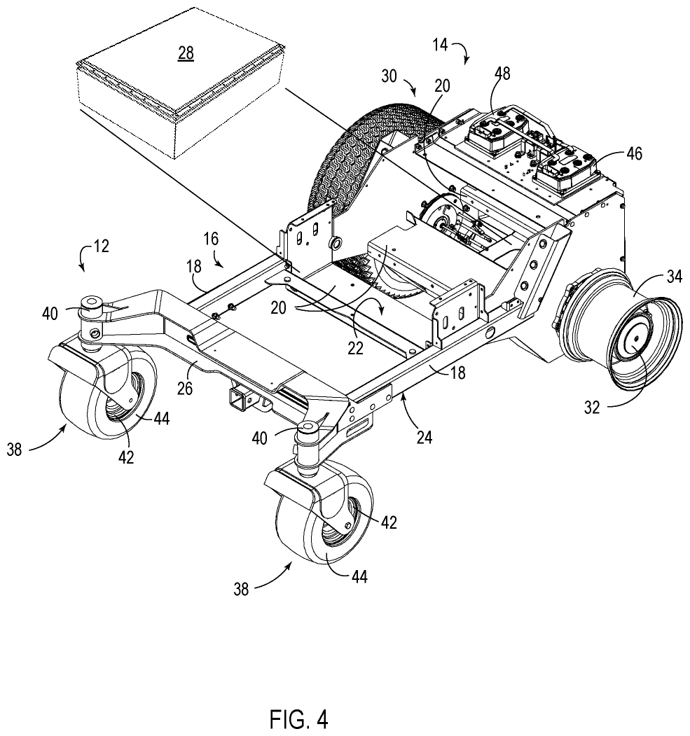

The machine 10 has a chassis 16 (FIG. 4) which provides structural support as well as mounting locations for the various components of the machine 10. Any material with adequate structural strength may be used to construct the chassis 16. Examples of suitable materials include metals such as aluminum and steel and their alloys. The chassis 16 may be monolithic or may be built up from smaller components, e.g., via fasteners, adhesives, or welding.

The chassis 16 includes a pair of spaced-apart main frame rails 18 extending in a longitudinal direction from the front end 12 of the machine 10 to the rear end 14 of the machine 10. Cross-members 20 interconnect the main frame rails 18. Top surfaces 22 of the cross-members 20 are positioned even with or lower than the bottom surfaces 24 of the main frame rails 18.

A front axle assembly 26 interconnects the main frame rails 18 at the front end 12 of the machine 10.

The machine 10 is equipped with an electric power pack 28 suitable for storing and discharging electric energy. In the illustrated example, the electric power pack 28 is a storage battery including one or more chemical cells, for example lithium ion cells. Other liquid battery chemistries may be substituted, as well as solid state batteries, capacitors, or similar devices which may exist currently or be later developed. The electric power pack 28 may include ancillary electric components such as inverters, transformers, voltage converters, relays, circuit breakers, and/or sensors. In the illustrated example, the electric power pack 28 includes at least one set of terminals providing a high voltage output (e.g. 82 V) for operating the primary components of the machine 10, such as the drive wheels and mower deck or other powered implement. It also includes another set of terminals providing a low voltage output (e.g. 12 V) for operating the control systems of the machine 10 as well as certain accessories.

The electric power pack 28 is positioned on the cross-members 20 and may be secured by fasteners, clips, latches, or the like (not shown).

The electric power pack 28 is positioned such that some portion of it is located at or below the bottom surfaces 24 of the main frame rails 18. Stated another way, the electric power pack 28 is positioned “between” the main frame rails 18, rather than sitting above or on top of the main frame rails 18.

The machine 10 is equipped with a drive wheel assembly 30, one on each side. Each drive wheel assembly 30 includes an integral drive hub 32 containing an internal electric motor, gear reduction drive, an optional brake (not separately illustrated), a drive wheel 34, and a tire 36 mounted to the drive wheel 34. It is noted that wheels having a ground-engaging surface, and thus not requiring a separate tire, are known in the art. The integral drive hub 32 is physically mounted to the chassis 16 such that the drive wheel 34 can rotate relative to the chassis 16.

As will be described in further detail, the machine 10 is configured such that the wheel speed and direction of rotation can be controlled independently for the left- and right-side drive wheel assemblies 30. In the illustrated example, the drive wheel assemblies 30 are located at or near the rear end 14 of the machine 10. Alternatively, the drive wheel assemblies 30 could be located at or near the front end 12 of the machine 10.

The machine 10 is equipped with left- and right-side steer wheel assemblies 38. Each steer wheel assembly 38 includes a pivot assembly 40, a steer wheel 42, and a tire 44 mounted to the steer wheel 42. It is noted that wheels having a ground-engaging surface, and thus not requiring a separate tire, are known in the art. Each steer wheel assembly 38 is mounted to the chassis 16 such that the steer wheel 42 can rotate relative to the chassis 16 as well as pivot freely about an upright (vertical or near-vertical) axis. The steer wheel assemblies 38 function as casters and therefore passively steer the machine 10. As noted above, the principles described herein are also applicable to a non-zero-turn mower (not shown) using a conventional steering linkage to pivot (i.e., actively steer) some or all of the wheels.

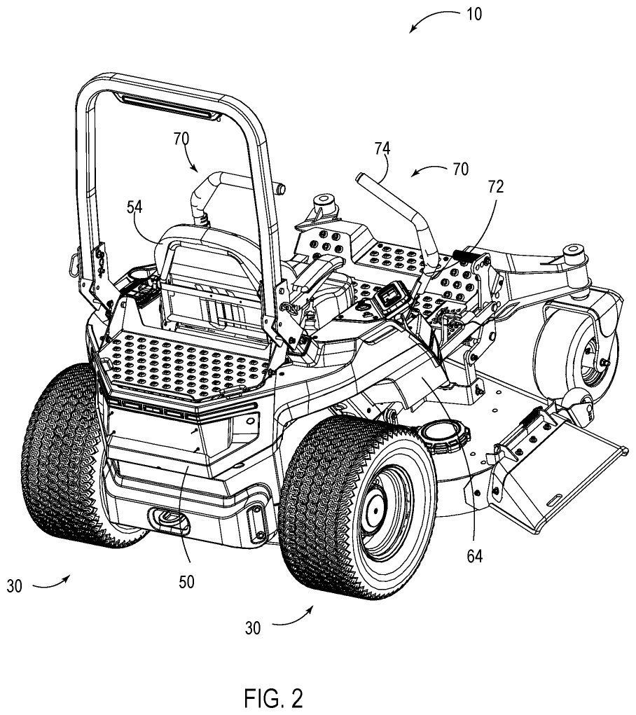

Referring now to FIGS. 1 and 2, the tires 36 and the steer wheel assemblies 38 extend beyond the chassis 16 and most other surfaces of the machine 10. In this regard, positions of the tires 36 and the steer wheels 38 are such that the tires 36 and the steer wheel assemblies 38 are likely to strike objects before most other surfaces of the more 10. In this regard, the position of the tires 36 and the steer wheel assemblies 38 protect other surfaces of the machine 10. Further, positioning of the rear tires such that they extend behind the body of the machine 10 reduces the effective turning radius making the machine 10 more maneuverable.

The machine 10 is equipped with suitable electric connections, controls, and switching equipment to permit the operator to control the drive functions of the machine 10. In the illustrated example, the machine 10 includes a left drive motor controller 46 and a right drive motor controller 48. Each of these drive motor controllers 46, 48 includes an electric power connection to the electric power pack 28 as well as connections to operator controls as described below. Each drive motor controller 46, 48 is operable to receive a command signal from an operator control and to provide electric power to drive its associated drive wheel assembly 30 at the commanded wheel speed and direction.

The machine 10 includes a body 50 or superstructure positioned above the chassis 16. The body 50 functions to enclose the operating components of the machine 10, to provide the mounting structure for controls and accessories of the machine 10, and to provide a desired external appearance.

The body 50 includes a battery cover assembly 52 which encloses the electric power pack 28.

An operator seat 54 is mounted on top of the battery cover assembly 52. The operator seat 54 may be adjustable in one or more directions, may include retractable armrests, and may include a seatbelt or other restraint for the operator. The battery cover assembly 52 and the operator seat 54 collectively define an “operator station” 56 which functions to support the operator in a position with access to machine controls during operation.

A foot deck 58 is mounted to the chassis 16 forward of the battery cover assembly 52. This serves as a support for the operator's feet. As illustrated, it may be provided with a raised tread structure to increase traction and avoid slippage.

A rollover protection system (“ROPS”) 60 is mounted to the body 50 just aft of the operator seat 54. This is a hoop-like structure or rollbar which extends above the operator's head in the seated position. This functions to prevent injury to the operator should the machine 10 rollover in operation. In the illustrated example, the rollover protection system 60 can be folded down or removed to permit operations under low-hanging structures or vegetation, or to make the machine 10 more compact for transportation.

The body 50 includes left and right fenders 62, 64 respectively which flank the left and right sides of the operator seat 54. The left fender 62 is topped by a left console 66 and the right fender 64 is topped by a right console 68.

The body 50 carries one or more operator controls within reach of the operator seat 54. The primary operator controls include a pair of steering levers 70, one for the left side and one for the right side. Each steering lever 70 is generally L-shaped and includes a vertical section 72 pivotally mounted to the body 50 near the forward edge of the operator seat 54, and a horizontal section 74 which extends from the top of the vertical section 72 towards the centerline X of the machine 10.

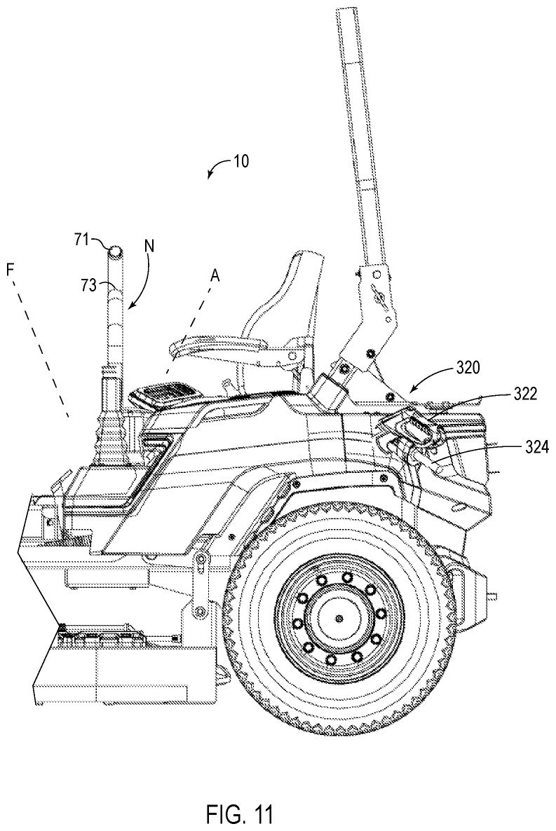

The machine 10 is configured such that fine speed control is determined by each steering lever 70. Referring to FIG. 11, each steering lever 70 is pivotally mounted such that it can move between a full forward position “F”, a neutral position “N”, and a full aft position “A” to provide fine control of drive wheel speed. The forward position F and the full aft position A are indicated by dashed lines in FIG. 11. More specifically, the steering lever 70 is spring-loaded to the neutral position N which commands drive wheel speed to stop and/or apply a brake. Movement in the forward direction away toward the forward position F from the neutral position N commands forward wheel rotation, with RPM proportional to steering lever deflection. Movement in the rearward direction away from the neutral position commands reverse wheel rotation, with RPM proportional to steering lever deflection. Stated another way, wheel rotation RPM is 0 when the lever 70 is in the neutral position N, wheel rotation RPM is at a forward maximum when the lever 70 is in the forward position F, and wheel rotation RPM is at 50% of the forward maximum when the lever 70 is midway between the forward position F and the neutral position N. Likewise, for reverse, wheel rotation RPM is 0 when the lever 70 is in the neutral position N, wheel rotation RPM is at a reverse maximum when the lever 70 is in the aft position A, and wheel rotation RPM is at 50% of the reverse maximum when the lever 70 is midway between the aft position and the neutral position N. It is also possible to employ a non-linear slope in the speed versus steering lever position relationship.

In the illustrated embodiment, the forward maximum wheel rotation RPM for a given range in the forward direction is equal to the reverse maximum wheel rotation RPM in the reverse direction for that same range. Alternatively, the maximum wheel rotation RPM for a given range in the forward direction may be different than the maximum wheel rotation RPM in the reverse direction for that same range. For example, in such embodiments the wheel rotation RPM in the reverse direction could be lower than that in the forward direction to provide for better control when the machine 10 is moving in reverse.

Continuing to refer to FIG. 11, a drive speed control button 71 is positioned at the end of one of the levers 70 and a blade speed control button 73 is positioned at the end of the other lever 70. In the illustrated embodiment, the drive speed control button 71 is positioned on the right side steering lever 70. Each control button 71 and 73 is electrically connected to the control system and to generate a signal determining gross speed of the drive motor controllers 46, 48 and to the blade motors, respectively. As used herein, the term “gross speed” refers to a speed range selected from a group of speed ranges such as low, medium, and high. It should be appreciated that the maximum speed of the affected motor in the low-speed range is lower than the maximum speed of the affected component in the medium speed range which in turn is lower than the maximum speed of the affected component in a high-speed range. The affected components for the button 71 are the drive motor controllers 46, 48. The affected component for the button 73 is the blade motor (described in more detail below).

Each control button 71 and 73 is configured to cycle through the associated gross speed ranges. In this regard, the pressing of either of control buttons 71 and 73 generate a discrete progression signal respectively. The control system interprets an incoming progression signal from either of the control buttons 71 and 73 as an instruction to progress from one gross speed range to another in a predetermined order. According to the illustrated embodiment such a progression would occur as follows: to the medium range from the low range, to the high range from the medium range, and to the low range from the high range.

Control buttons 71 and 73 are positioned such that an operator can press them with a thumb or other portion of a hand or finger while grasping the respective lever 70.

Each steering lever 70 is further pivotally mounted so that it can move in a lateral direction between an outboard parking position and a inboard use position.

Optionally, the machine 10 may be equipped with parking switches (not illustrated) which are operable to detect if the steering levers 70 are in the outboard position or the inboard position. The parking switches may be configured such that the machine drive wheel assemblies 30 cannot be operated unless both steering levers 70 are pivoted to the inboard position.

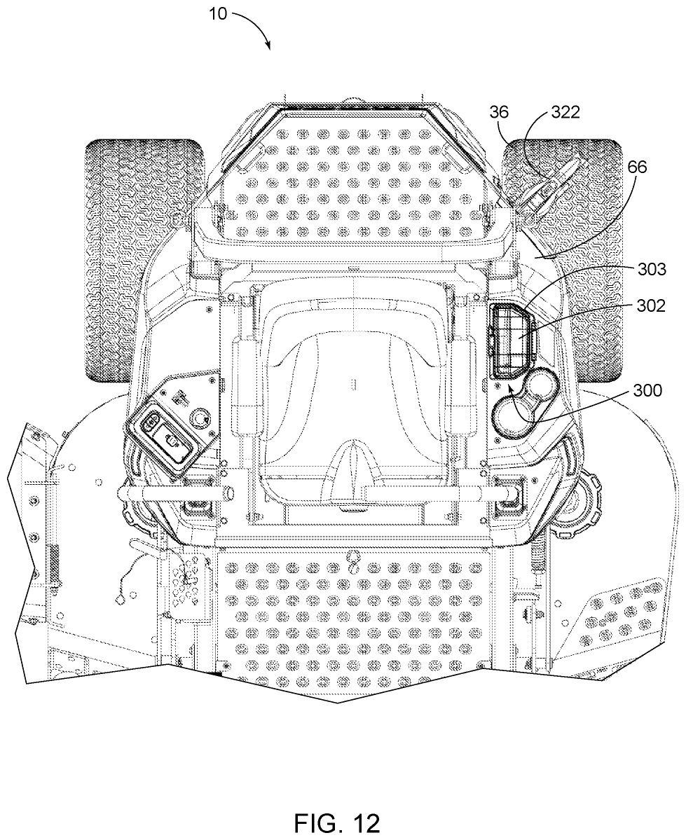

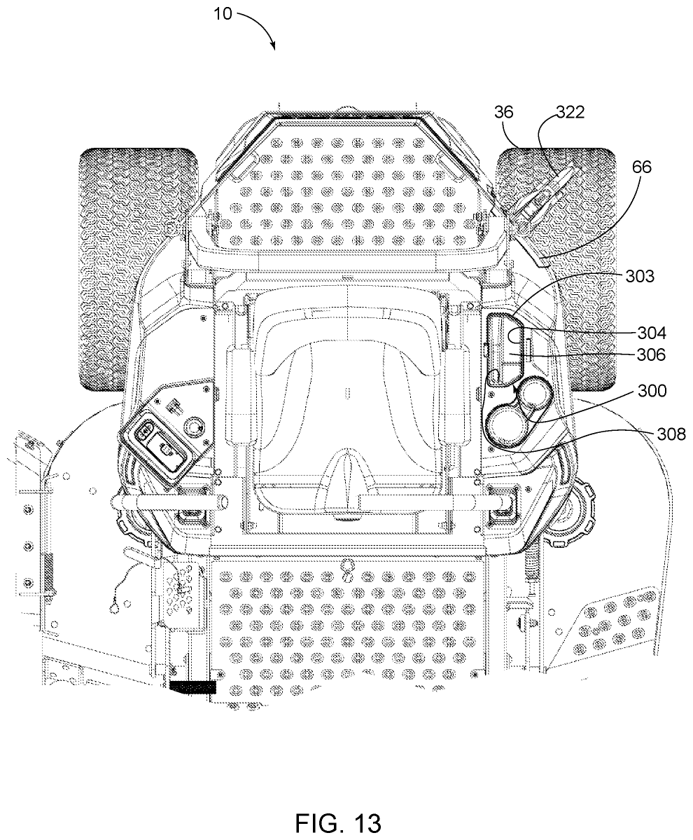

Referring now to FIGS. 12 and 13, the machine 10 includes at least one water resistant storage pocket 300. The pocket 300 includes a lid 302 (shown in FIG. 12 but not shown in FIG. 13), a gasket 303, and a wall 304. The wall 304 is defined by the left console 66. The wall 304 defines a receptacle 306. which is configured to receive, by way of example and not limitation, items such as cell phones, wallets, keys, and the like. A USB charger port 308 is positioned within the wall 304 such that the port 308 is accessible from the receptacle 306. The USB charger port 308 is electrically connected to the electric power pack 28 such that a device is rechargeable via the USB charger port 308. By way of example and not limitation, the devices that can be charged via the USB charger port 308 include cell phones, earbuds, and the like. The machine 10 can be configured such that the USB charger port 308 is active when the machine 10 is in operation only or such that the USB charger port is active both the machine 10 is in operation and the machine 10 is not in operation.

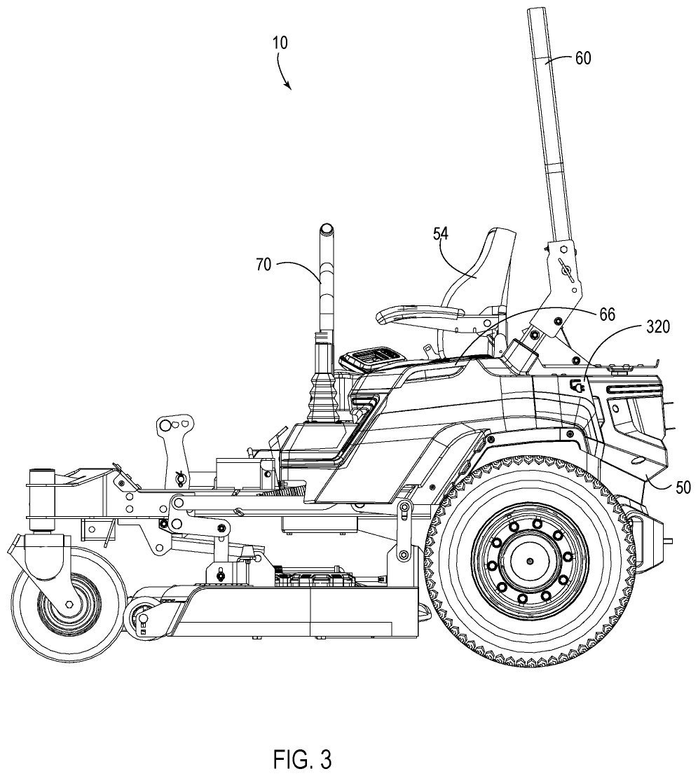

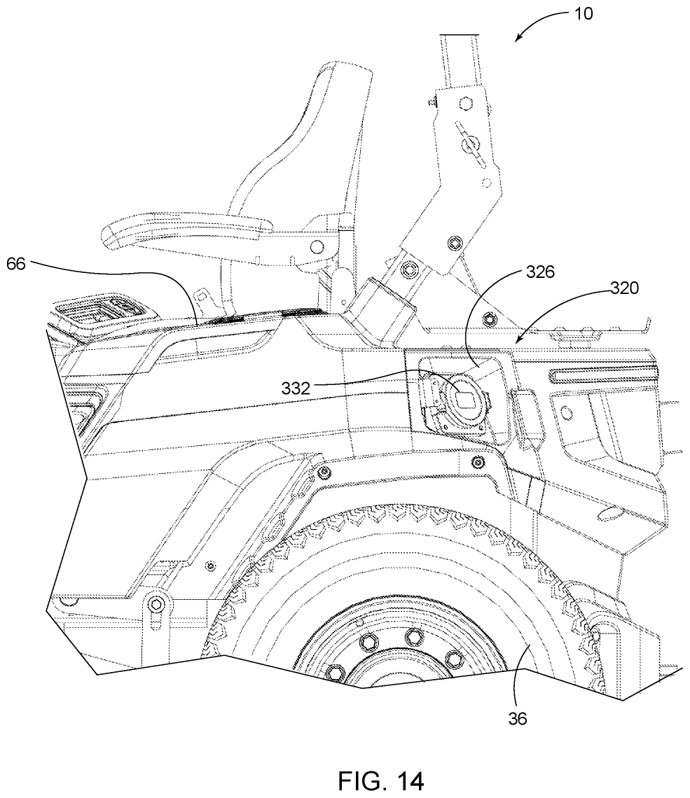

Referring now to FIGS. 11, 13 and 14, the machine 10 includes a charging port 320 that is configured to facilitate transfer of electricity for charging to the electric power pack 28. The charging port 320 is configured to receive a plug 322 that is connected to a source for electricity (not shown) by a cable 324. According to the illustrated embodiment, the plug 322 is Asian GB/T standard. It should be appreciated that in other embodiments the charging port 320 is configured to receive other types of plugs. The charging port 320 is accessible through an opening 326 defined in the left console 66 and covered by a console cover 328 (See FIG. 3). The charging port 320 includes a hinged cover 332 configured to mate with a rim 334. The rim 334 is sized to receive the plug 322. The hinged cover 332 is removed for clarity and FIG. 14. The charging port includes electric connectors 336 that are configured to connect with corresponding connectors included in the plug 322.

The charging port 320 is oriented at an angle relative to a vertical such that the plug 322 angles upwardly away from the port 320. In this manner, the cable 324 is guided upwardly above and away from the left side tire 36 when the plug 322 is engaged with the charging port 320. In this regard, a flange 342 extends away from the rim 334 and defines a surface 344. The surface 344 defines the angle alpha of the plug 322 relative to vertical as represented by the dashed line shown in FIG. 14. Preferably, the angle alpha is between 30° and 60°, more preferably the angle alpha (α) is between about 35° and 55° more preferably, the angle alpha is between about 40° and 45°.

Further controls are not separately illustrated but can include one or more of the following: a key switch or other security device; a main power switch; an emergency stop control; a blade start/stop switch; a blade speed control; a drive speed limiter or cruise control; and lighting controls. These further controls may be mounted, for example to the left or right consoles 66, 68.

The outdoor power machine 10 may be used as follows. First, the operator sits in the operator seat 54 and activates the key switch or main power switch. A blade start/stop switch or other switch is used to turn on mowing blades or other powered implement, and the implement is adjusted to an operating position, such as a desired cutting height for mowing. The steering levers 70 are moved from the outboard parking position to the inboard use position. The operator then uses the steering levers 70 to drive the outdoor power machine 10 in the desired direction while mowing or other implement operation takes place. It will be understood from the above description that manipulation of the steering levers 70 is sufficient to control forward and aft movement of the outdoor power machine 10, as well as braking and steering.

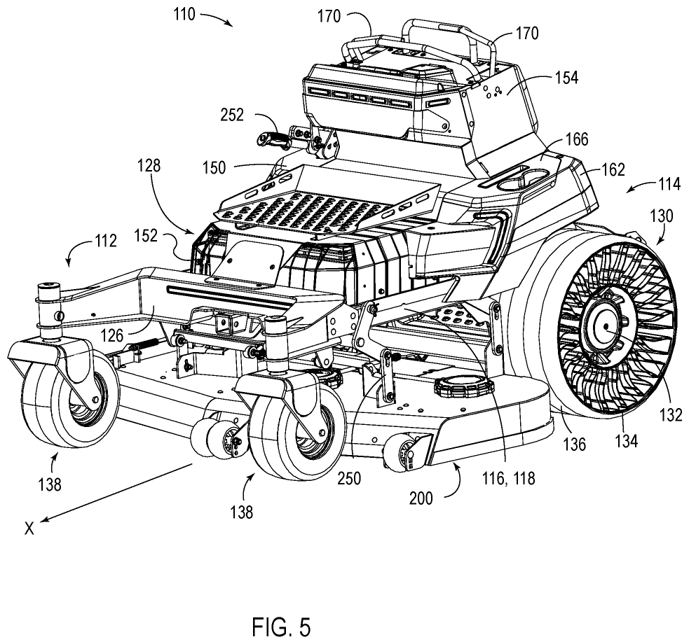

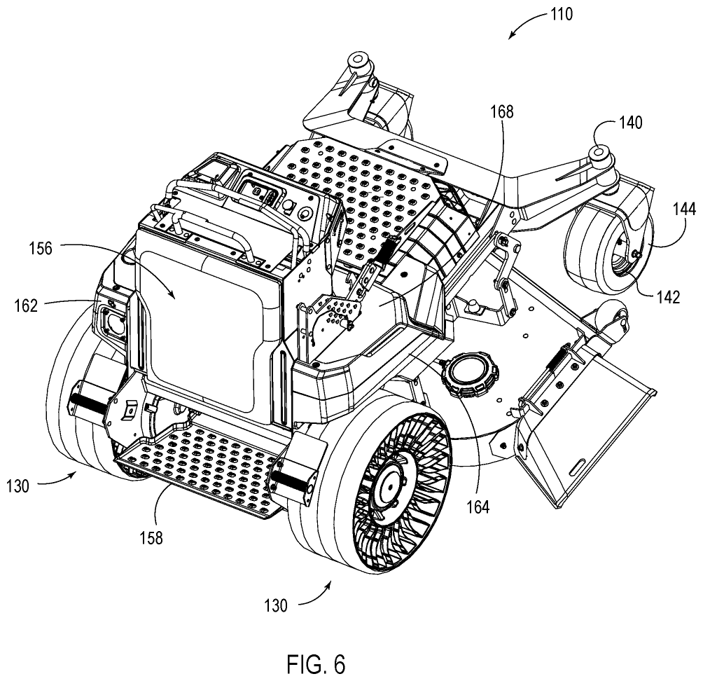

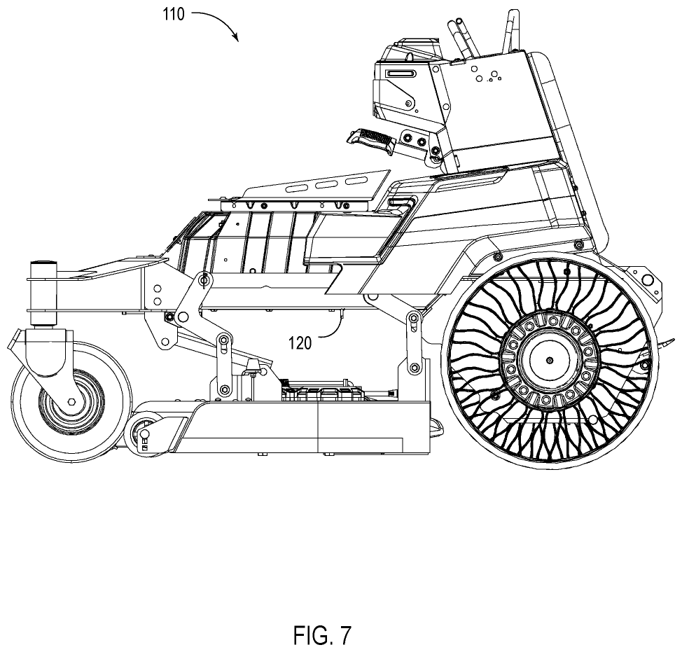

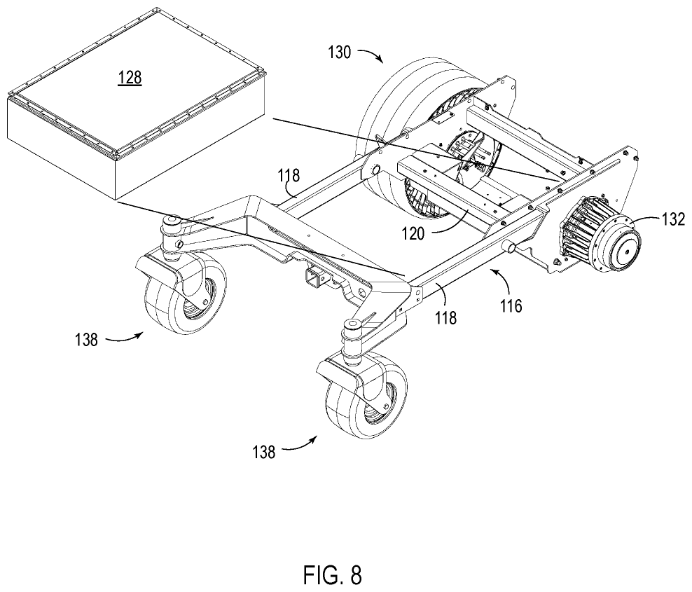

FIGS. 5-8 illustrate another exemplary embodiment of an outdoor power machine 110. This embodiment of the machine 110 is a stand-on machine (alternatively referred to as a “stander”). The overall construction of the machine 110 is similar to the machine described above. Elements of the machine 110 not explicitly described may be taken to be identical to the machine 110 described above.

The machine 110 has a chassis 116 including main frame rails 118 extending in a longitudinal direction from a front end 112 of the machine 110 to a rear end 114 of the machine 110. Cross-members 120 interconnect the main frame rails 118. A front axle assembly 126 interconnects the main frame rails 118 at the front end 112 of the machine 110.

The machine 110 is equipped with an electric power pack 128 as described above.

The machine is equipped with left- and right-side drive wheel assemblies 130. Each drive wheel assembly 130 includes an integral drive hub 132 containing an electric motor, a gear reduction drive, and an optional brake (not separately illustrated), a drive wheel 134, and a tire 136 mounted to the drive wheel 134. It is noted that wheels having a ground-engaging surface, and thus not requiring a separate tire, are known in the art. In the illustrated example, the drive wheel assemblies 130 are located at or near the rear end 114 of the machine 110. Alternatively, the drive wheel assemblies 130 could be located at or near the front end 112 of the machine 110.

The machine 110 is equipped with left- and right-side steer wheel assemblies 138. Each steer wheel assembly 138 includes a pivot assembly 140, a steer wheel 142, and a tire 144 mounted to the steer wheel 142. It is noted that wheels having a ground-engaging surface, and thus not requiring a separate tire, are known in the art. Each steer wheel assembly 138 is mounted to the chassis 116 such that the steer wheel 142 can rotate relative to the chassis 116 as well as pivot freely about an upright (vertical or near-vertical) axis. The steer wheel assemblies 138 function as casters and therefore passively steer the machine 110. As noted above, the principles described herein are also applicable to a non zero-turn mower (not shown) using a conventional steering linkage to pivot (i.e., actively steer) some or all of the wheels.

The machine 110 is equipped with suitable electrical connections, controls, and switching equipment to permit the operator to control the drive functions of the machine 110. In the illustrated example, the machine 110 includes a left drive motor controller and a right drive motor controller (not visible in the figures). Each of these drive motor controllers includes a electrical power connection to the electric power pack 128 as well as connections to operator controls as described below. Each drive motor controller is operable to receive a command signal from an operator control and to provide electric power to drive its associated drive wheel assembly 130 at the commanded wheel speed and direction.

The machine 110 includes a body 150 or superstructure positioned above the chassis 116.

The body 150 includes a battery cover assembly 152 which encloses the electric power pack 128. A control pedestal 154 is mounted on top of the battery cover assembly 152.

A foot deck 158 is mounted to the chassis 116 aft of the battery cover assembly 152. This serves as a support for the operator's feet. As illustrated, it may be provided with a raised tread structure to increase traction and avoid slippage. The battery cover assembly 152, the control pedestal 154, and the foot deck 158 collectively define an “operator station” 156 which functions to support the operator to provide access to machine controls during operation.

The body 150 includes left and right fenders 162, 164 respectively which flank the left and right sides of the control pedestal 154. The left fender 162 is topped by a left console 166 and the right fender 164 is topped by a right console 168.

The body 150 carries one or more operator controls within reach of the operator station 156. The primary operator controls include a pair of steering levers 170, one for the left side and one for the right side. Each steering lever 170 is generally L-shaped and includes a vertical section pivotally mounted to the control pedestal 154, and a horizontal section which extends from the top of the vertical section towards the centerline X of the machine 110. Each steering lever 170 is pivotally mounted such that it can move in a fore-aft direction to control drive wheel speed as described above.

Each steering lever 170 is further pivotally mounted so that it can move in a lateral direction between an outboard parking position and a inboard use position. Optionally, the machine 110 may be equipped with parking switches as described above.

Further controls are not separately illustrated but can include one or more of the following: a key switch or other security device; a main power switch; an emergency stop control; a blade start/stop switch; the blade speed control; a drive speed limiter or cruise control; and lighting controls. These further controls may be mounted, for example to the control pedestal 154 or to the left or right consoles 166, 168.

Any of the outdoor power machines described herein may be may be equipped with one or more implements, defined generally as a device attached to or carried by the machine and operable to cut, shape, load, lift, move, or transport material. Nonlimiting examples of implements include mowing decks, plows, disks, scarifiers, rippers, aerators, dethatchers, blades, buckets, scrapers, or blowers.

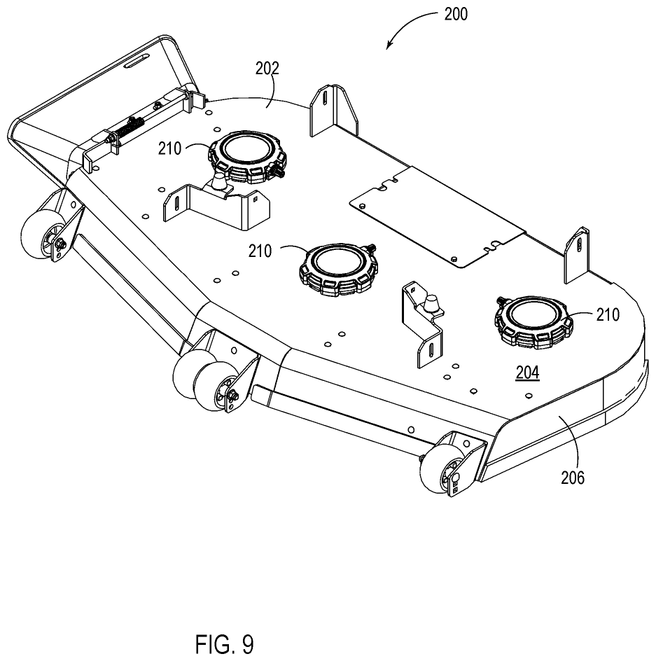

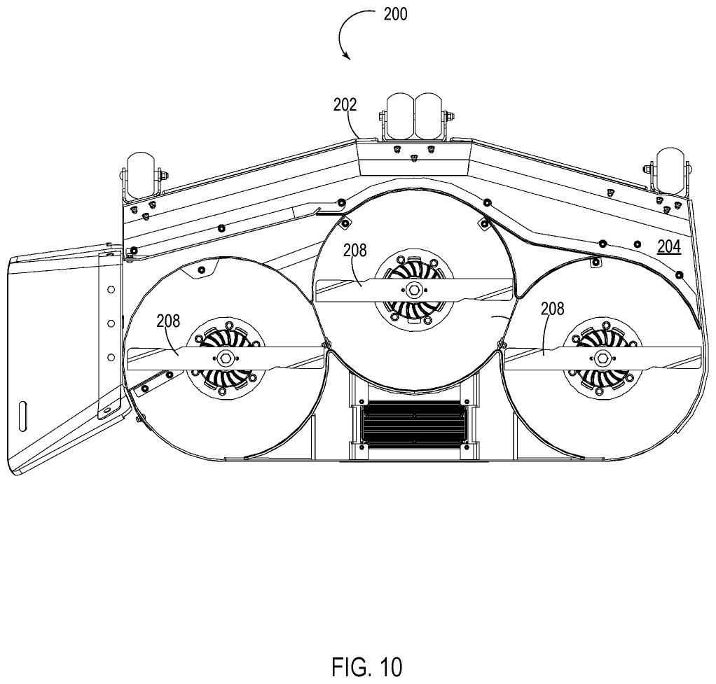

In the illustrated example, the machine 10 or 110 is equipped with a mowing deck assembly 200 (FIGS. 9, 10). It includes a deck 202 which is an open-bottomed enclosure including a top panel 204 and a peripheral wall 206.

The deck 202 has a nominal designated width which may be selected to provide a desired cutting swath. Non-limiting examples of suitable deck widths include 48 inches, 52 inches, 60 inches, or 72 inches.

One or more mowing blades 208 are rotatably mounted on the underside of the top panel 204. The mowing blades 208 are positioned in a side-by side configuration such that their tips will not collide in operation. The mowing blades 208 may be positioned to have some overlap in at least one dimension so as to prevent un-mowed strips during mower operation. The dimensions of the individual mowing blades 208 are selected to provide adequate structural strength at selected operating speed, (e.g. 3600 RPM). Generally, the size of the individual mowing blades 208 is equal to the deck width divided by the number of mowing blades 208, with some additional diameter provided to accommodate for swath overlap. For example, a deck 202 having a nominal width of 60 inches may use three mowing blades 208 each having a diameter of 20.5 inches.

As indicated above, means are provided for driving the mowing blades 208. Nonlimiting examples of suitable drive methods include mechanical, hydraulic, or electrical devices. In the illustrated example, each mowing blade 208 is directly driven by its own individual electric blade motor 210.

The mowing deck assembly 200 is connected to the chassis via a deck lift. The deck lift is operable to position the mowing blades 208 at a preselected distance above the ground plane G of the machine. Typical examples include a cutting height in the range of approximately 1 inch to approximately 6 inches. The deck lift is also operable to lift the mowing deck assembly 200 well above any intended cutting height so that the machine can traverse obstacles, travel along a road to a worksite, or be loaded or unloaded from a trailer or storage building. This is referred to as a “travel position”.

In the example shown in FIGS. 1-4, a deck lift 230 includes a foot pedal 232 to raise the deck lift 230. A removable pin 234 is insertable into a selected hole in a blade height adjuster 236. The position of the pin 234 determines a cutting height by blocking the deck lift 230 at a specific position. An uplock lever 238 is provided to selectively lock and release the deck lift 230 in the travel position.

In the example shown in FIGS. 5-7, the mowing deck assembly 200 is connected to the chassis 116 via a deck lift 250. The deck lift 250 is similar to the deck lift 230 described above, the primary difference being that is operated by a hand lever 252 as opposed to a pedal.

The machine described herein has advantages over prior art machines. The steering levers and the control buttons of the machines described above allow for the operator to affect smooth and efficient selection of speed and control of speed both from gross ranges such as low medium and high and fine control within of those ranges. This advantage also applies to the speed of the cutting blade. The water resistant pocket described above allows for safe and convenient storage of devices and personal items of an operator. Further, charging of devices such as phones is also possible within the water resistant pocket. Another advantage of the machine described above is that the charging port is positioned such that a charging cable is angled clear of the tires thus reducing abrasive wear of the cable against the tires. The tires of the machine described above are also position such that they generally absorbed more impact was struck objects than the body of the machine. In this regard more easily replaceable tires protect the body of the machine.

The foregoing has described an outdoor power machine. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends, or to any novel one, or any novel combination, of the steps of any method or process so disclosed.

What is claimed is:

1. An outdoor power machine, comprising:
a chassis;
two or more drive wheel assemblies physically mounted to the chassis, each drive wheel assembly coupled to an electric motor;
an electric power pack configured to supply electric energy to the electric motors;
one or more steer wheels;
a steering lever;
a speed control button positioned on the steering lever; and
wherein the speed control button is configured to send a signal to a control system such that the control system sequentially selects a gross speed range.

2. The outdoor power machine of claim 1, wherein the control system is configured to sequentially cycle through a predetermined set of speed ranges.

3. The outdoor power machine of claim 2, wherein there are three speed ranges that each have different maximum speeds.

4. The outdoor power machine of claim 3, wherein the speed ranges are low, medium, and high.

5. The outdoor power machine of claim 1, wherein the speed control button is configured to control the speed of at least one of the drive wheel assembly.

6. The outdoor power machine of claim 1, wherein the speed control button is configured to control the speed of a means for driving a blade.

7. The outdoor power machine of claim 1, wherein the speed control button is positioned at the distal end of the steering lever.

8. An outdoor power machine, comprising:
a chassis;
two or more drive wheel assemblies physically mounted to the chassis, each drive wheel assembly coupled to an electric motor;
an electric power pack configured to supply electric energy to the electric motors;
one or more steer wheels;
a body mounted to the chassis; and
at least one water resistant storage pocket defined by the body.

9. The outdoor power machine of claim 8, wherein the water resistant storage pocket includes a lid.

10. The outdoor power machine of claim 9, wherein the water resistant storage pocket is configured to receive an electronic item.

11. The outdoor power machine of claim 10, wherein the water resistant storage pocket includes a USB charger port.
